(19) United States
(12) Patent Application Publication
(10) Pub. No.: US 2013/0004224 A1
(43) Pub. Date: Jan. 3, 2013

(54) ELECTRONIC DEVICE

(75) Inventor: Yoshihiko Iwata, Tokyo (JP)

(73) Assignee: CASIO COMPUTER CO., LTD., Tokyo (JP)

(21) Appl. No.: 13/495,162

(22) Filed: Jun. 13, 2012

(30) Foreign Application Priority Data
Jun. 30, 2011 (JP) 2011-145490

(51) Int. Cl. B41J 11/04

(52) U.S. Cl. 400/611

(57) ABSTRACT

An electronic device of the present invention is provided with a printer that selectively houses any one of a plurality of paper rolls for different paper widths within a device body, includes a first housing section which houses a first paper roll having a first paper width corresponding to the paper width, a second housing section which houses a second paper roll having a second paper width that is narrower than the first paper width corresponding to the paper width, and a paper roll guiding section which guides the first paper roll or the second paper roll inserted into the electronic device to either one of the first housing section and the second housing section corresponding to the paper width, by providing the bottom section of the second housing section that is a step lower than the bottom section of the first housing section.

### CROSS-REFERENCE TO RELATED APPLICATION

This application is based upon and claims the benefit of priority from the prior Japanese Patent Application No. 2011-145490, filed Jun. 30, 2011, the entire contents of which is incorporated herein by reference.

### BACKGROUND OF THE INVENTION

1. Field of the Invention

The present invention relates to an electronic device, such as an electronic register, a mobile information terminal, or a photocopier.

2. Description of the Related Art

In electronic devices such as a mobile information terminal having a printer, an electronic device such as that described in Japanese Patent Application Laid-Open (Kokai) Publication No. 62-083953 is known, which is structured so that the user can select either one of two types of paper rolls having different paper widths and house the selected paper roll in its predetermined position. In this electronic device, a positioning member is provided inside a paper roll housing section that restricts the position of a paper roll having a wider paper width, whereby a paper roll having a narrower paper width can be housed in its predetermined position when it is selected.

The paper roll housing section of this electronic device is formed having a width that can restrict the positions of both side surfaces of the paper roll having the wider paper width, and the positioning member provided inside the paper roll housing section has a pair of flat spring sections that restrict the positions of both side surfaces of the paper roll having the narrower paper width. These flat spring sections are arranged obliquely within the paper roll housing section and, in this state, resiliently pressed downward by the paper roll having the wider paper width.

As a result, when the paper roll having the wider paper width is to be housed within the paper roll housing section in the electronic device, it presses the pair of flat spring sections of the positioning member downward and then is housed within the paper roll housing section. When the paper roll having the narrower paper width is to be housed, the positions of its side surfaces are restricted by the pair of flat spring sections of the positioning member, whereby it is housed in a predetermined position inside the paper roll housing section.

However, in this electronic device, the positioning member is required which restricts, among the two types of paper rolls having differing paper widths, the paper roll having the narrower paper width to its predetermined position inside the paper roll housing section. In addition, the positioning member is required to be placed and attached in a predetermined position inside the paper roll housing section, and accordingly there is a problem with this paper roll housing structure in that the structure is complicated, the number of the components is large, the assembly operation is complicated and troublesome, and the manufacturing cost is high.

### SUMMARY OF THE INVENTION

An object of the present invention is to reduce the number of the components of an electronic device such as that described above and thereby reduce the cost by using a simpler structure.

In order to achieve the above-described object, in accordance with one aspect of the present invention, there is provided an electronic device having a printer that selectively houses any one of a plurality of paper rolls for different paper widths within a device body comprising: a first housing section which houses a first paper roll having a first paper width corresponding to the first paper width; a second housing section which houses a second paper roll having a second paper width that is narrower than the first paper width corresponding to the second paper width; and a paper roll guiding section which guides the first paper roll or the second paper roll inserted into the electronic device to either one of the first housing section and the second housing section corresponding to the first paper width or the second paper width, by providing a bottom section of the second housing section in a bottom section of the first housing section that is a step lower than the bottom section of the first housing section.

According to the present invention, when the first paper roll is to be housed, the paper roll guiding section guides it into the first housing section corresponding to the paper width, whereby it can be favorably housed. Also, when the second paper roll is to be housed, the paper roll guiding section guides it into the second housing section corresponding to the paper width, whereby it can be favorably housed.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a perspective view of an embodiment where the present invention has been applied to an electronic register;

FIG. 2 is a perspective view of the electronic register shown in FIG. 1 when viewed from the rear side;

FIG. 3 is a planar view of the electronic register shown in FIG. 1;

FIG. 4 is a front view of the electronic register shown in FIG. 1;

FIG. 5A and FIG. 5B are side views of the electronic register shown in FIG. 1 when viewed from the right side, of which FIG. 5A is a side view when an input display unit is arranged on a device body at a slight tilt, and FIG. 5B is a side view when the input display unit is erected on the device body by the rear portion being pulled up;

FIG. 6A and FIG. 6B are side views of the electronic register shown in FIG. 1 when viewed from the left side, of which FIG. 6A is a side view when a rotational display unit is housed within a display housing section of the device body, and FIG. 6B is a side view when the rotational display unit is pulled upward above the device body;

FIG. 7 is a perspective view of the main section of the electronic register in FIG. 1, in which a paper roll housing section is shown by the input display unit being removed and a portion of a printer cover being cut away;

FIG. 8 is a perspective view in which the paper roll housing section shown in FIG. 7 is further enlarged;

FIG. 9 is an enlarged cross-sectional view of the paper roll housing section taken along line A-A in FIG. 8;

FIG. 10 is an enlarged cross-sectional view in which a first paper roll having a wider paper width is housed within a first housing section of the paper roll housing section shown in FIG. 9; and

FIG. 11 is an enlarged cross-sectional view in which a second paper roll having a narrower paper width is housed within a second housing section of the paper roll housing section shown in FIG. 9.

### DETAILED DESCRIPTION OF THE PREFERRED EMBODIMENT

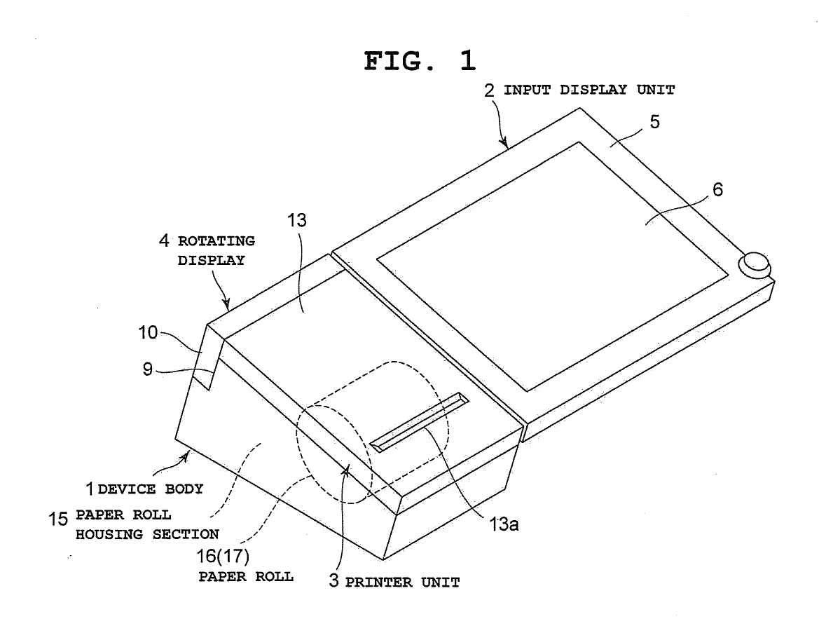

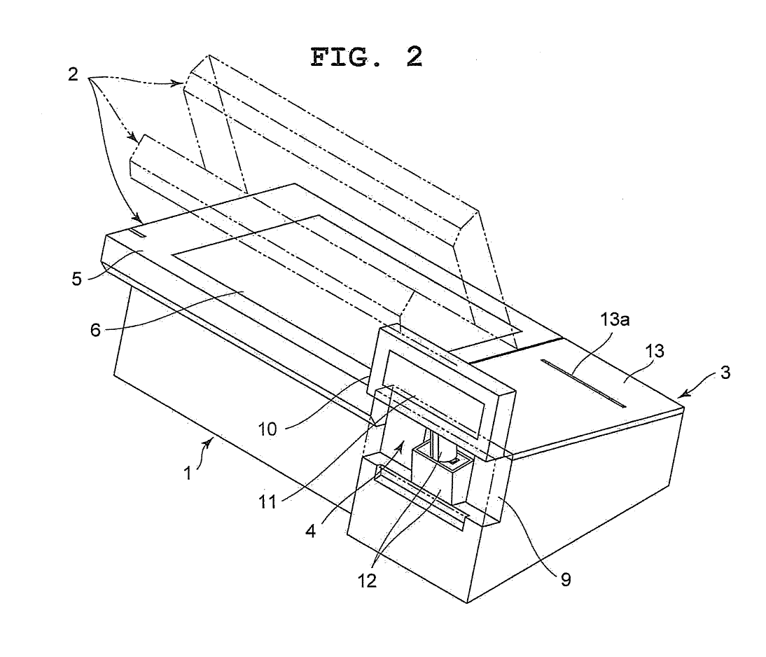

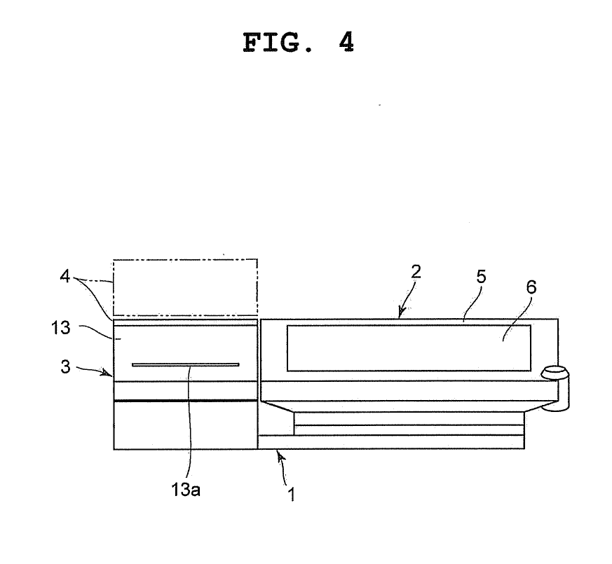

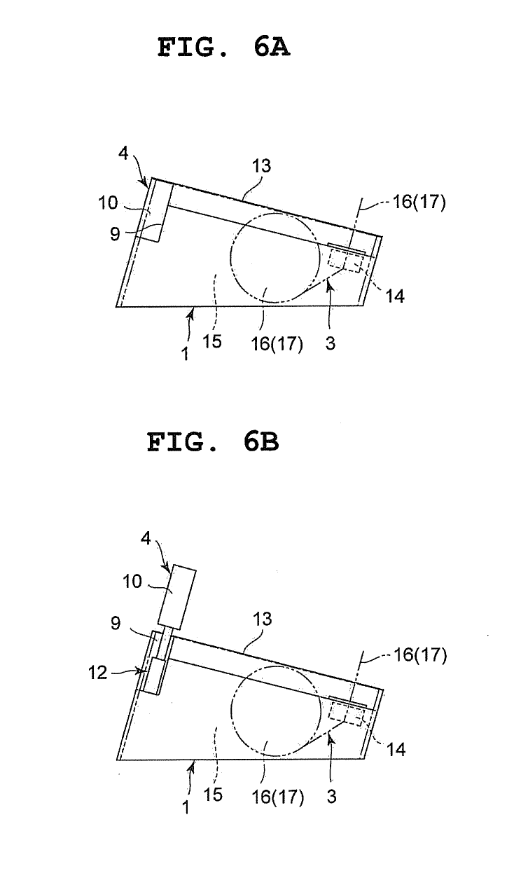

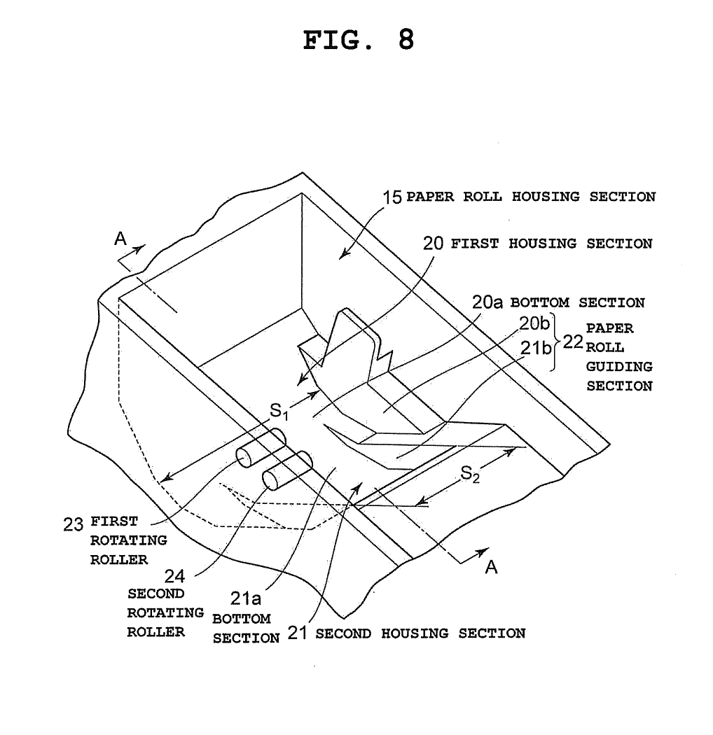

An embodiment where the present invention has been applied to an electronic register will hereinafter be described with reference to FIG. 1 to FIG. 11. This electronic register includes a device body 1 as shown in FIG. 1 and FIG. 2, which is mounted with an input display unit 2, a printer unit 3, and a rotational display unit 4.

As shown in FIG. 1 to FIG. 5, the input display unit 2 is provided with a touch input section 6 on the top surface of a unit case 5, and configured such that the operator inputs information regarding a product to be purchased by a customer, by performing a touch operation on the touch input section 6. In this instance, the touch input section 6 is structured by a transparent touch panel being arranged on the top surface of a display panel (not shown).

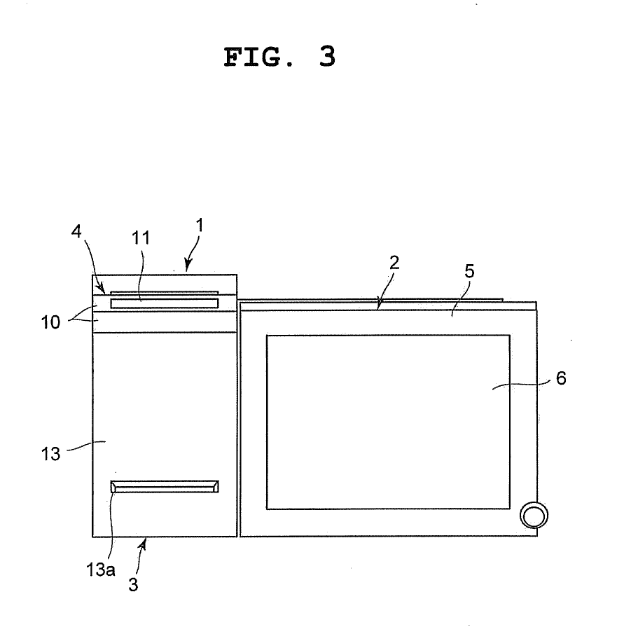

The touch input section 6 is configured such that the operator inputs information regarding a product to be purchased, by performing a touch operation on the touch panel while viewing information displayed on the display panel, and the inputted information is displayed on the display panel. In this instance, as shown in FIG. 1 to FIG. 5, the unit case 5 is arranged on the device body 1 excluding a certain portion (the left-side section in FIG. 3), in a downwardly inclined state toward the front.

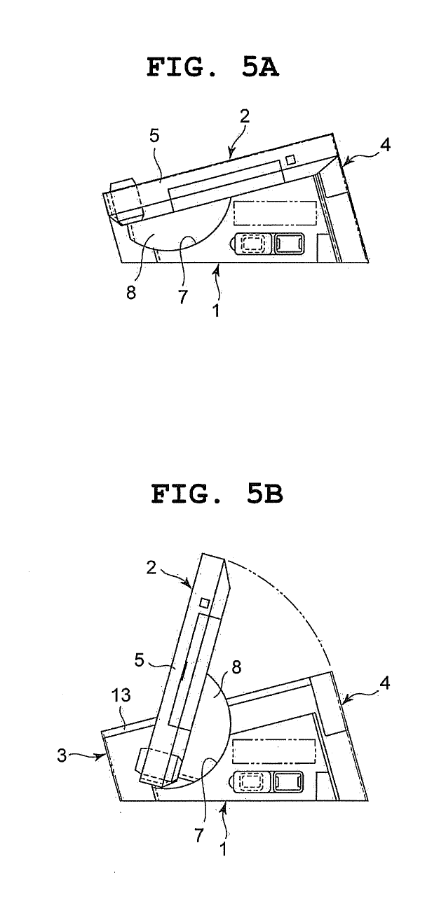

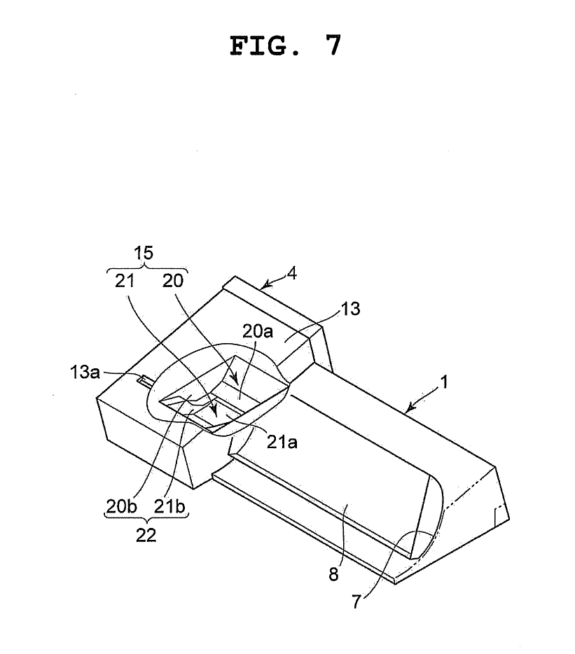

That is, a circular-arc-shaped supporting recess section 7 is provided in the front upper portion of the device body 1, and a semicircular cylindrical rotating projection section 8 is provided on the bottom surface of the unit case 5, as shown in FIG. 5 and FIG. 7. As a result, the unit case 5 is structured such that, when the semicircular cylindrical rotating projection section 8 on the bottom surface of the unit case 5 is arranged on the circular-arc-shaped supporting recess section 7 in the device body 1 and the unit case 5 is rotated and moved in a front-back direction on the supporting recess section 7, the rear portion (the right side in FIG. 5B) of the unit case 5 is raised, whereby the unit case 5 is tilted.

The rotational display unit 4 is used to display information inputted by the operator and enable the customer to view the displayed information. In the structure of the rotational display unit 4, a display panel 11 that displays information is provided in a display case 10. The display case 10 is supported by a supporting mechanism 12 that enables it to telescopically move in a vertical direction relative to the device body 1, as shown in FIG. 1 to FIG. 4. In this instance, the display case 10 is formed into a shape of a laterally elongated rectangular box, as shown in FIG. 2.

In addition, the display panel 11, which is constituted by a flat-screen display element such as a liquid crystal display element or an electroluminescent (EL) display element, is arranged in a laterally elongated state on the rear side surface of the display case 10, and electro-optically displays various information required by the electronic register, such as information inputted by the operator. As shown in FIG. 1 to FIG. 4 and FIG. 6, the rotational display unit 4 is housed within a display housing section 9 provided on the rear surface of the device body 1 that is upwardly movable.

On the other hand, the printer unit 3 is arranged to the left of the input display unit 2 of the device body 1, and includes a printer cover 13 openably and closably arranged on the device body 1, a printer section 14 provided inside the device body 1 to be positioned below the printer cover 13, and a paper roll housing section 15 provided inside the device body 1 to be positioned near the printer section 14, as shown in FIG. 1 to FIG. 9.

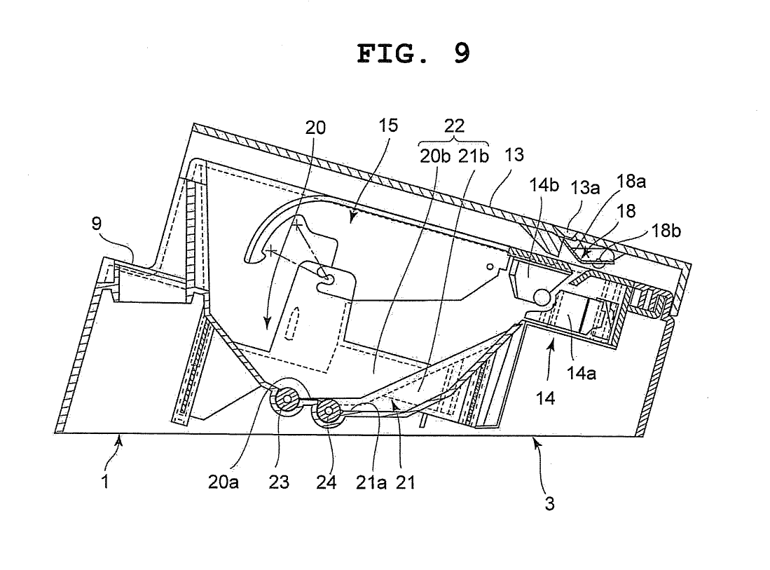

The printer cover 13 is arranged on the device body 1 at almost the same height as the top surface of the input display unit 2, in a downwardly inclined state toward the front, as shown in FIG. 1 to FIG. 4. The printer section 14 includes a print section 14a and a platen section 14b, and is structured to print information on either of the paper rolls 16 and 17 described hereafter which has been fed between the print section 14a and the platen section 14b, and feed out the printed paper roll 16 or 17, as shown in FIG. 9.

In this instance, the printer section 14 is structured to, when print information is printed on either of the paper rolls 16 and 17, eject the printed paper roll 16 or 17 outside of the device body 1 from a recording paper ejection port 13a provided in the printer cover 13, as shown in FIG. 9 to FIG. 11. Also, a drip-proof shutter 18 that is rotatable in an up and down direction is provided below this recording paper ejection port 13a.

This drip-proof shutter 18 includes a shutter plate 18a and a supporting shaft 18b, and is structured such that the shutter plate 18a is supported by the supporting shaft 18b to be rotatable in an up and down direction, as shown in FIG. 9. That is, the drip-proof shutter 18 is structured such that, when the shutter plate 18a is rotatably supported by the supporting shaft 18b, the shutter plate 18a rotates in a direction in which the recording paper ejection port 13a is closed by the weight balance, as shown in FIG. 9.

Also, the drip-proof shutter 18 is structured such that, when print information is printed on either of the paper rolls 16 and 17 by the printer section 14, the shutter plate 18a is rotated around the supporting shaft 18b by the force of the ejection of the printed paper roll 16 or 17, and the printed paper roll 16 or 17 is fed out towards the recording paper ejection port 13a, as shown in FIG. 9.

As shown in FIG. 7 to FIG. 11, the paper roll housing section 15 is structured to selectively house the plurality of paper rolls 16 and 17 having different paper widths. That is, the paper roll housing section 15 includes a first housing section 20 that houses the first paper roll 16 having a first paper width corresponding to the paper width, a second housing section 21 that houses the second paper roll 17 having a second paper width that is narrower than the first paper width corresponding to the paper width, and a paper roll guiding section 22 that guides the first paper roll 16 or the second paper roll 17 inserted into the paper roll housing section 15 to the first housing section 20 or the second housing section 21 corresponding to the paper width.

In this instance, the first housing section 20 is a recess section whose top is open, and its bottom section 20a is formed into a concave surface curved into a substantially circular-arc shape along the front and back directions (the right and left directions in FIG. 9) of the device body 1, as shown in FIG. 7 to FIG. 9. This first housing section 20 is formed such that the length S1 between the sides of the bottom section 20a formed into a concave surface, or in other words, between side wall sections 20b corresponding to the side surfaces of the first paper roll 16 is almost the same length as the paper width of the first paper roll 16.

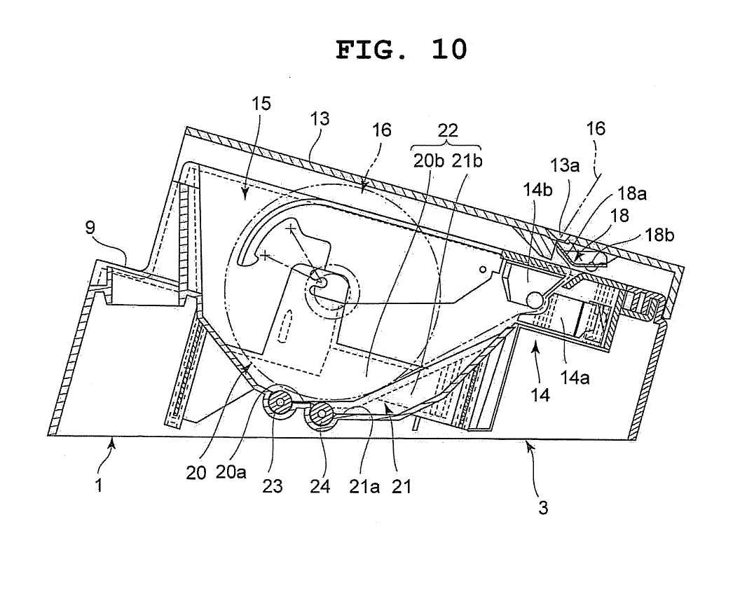

As a result, the first housing section 20 is structured such that, when the first paper roll 16 is inserted thereto from above, the first paper roll 16 rolls over the bottom section 20a formed into a concave surface curved into a substantially circular-arc shape in the first housing section 20, and is naturally arranged in the lowest portion of the bottom section 20a, as shown in FIG. 10.

Also, the second housing section 21 is a concave recess section that is a step lower than the bottom section 20a of the first housing section 20, as shown in FIG. 7 to FIG. 10. As in the case of the first housing section 20, the bottom section 21a of the second housing section 21 is formed into a concave surface curved into a substantially circular-arc shape which is almost the same as that of the bottom section 20a of the first housing section 20, along the front and back directions (the right and left directions in FIG. 9) of the device body 1, as shown in FIG. 7 to FIG. 9.

In this instance, the second housing section 21 is formed such that, because the bottom section 21a of the second housing section 20 is formed into a concave surface curved into a substantially circular-arc shape that is a step lower than the bottom section 20a of the first housing section 20, the length 32 between the sides of the bottom section 21a formed into a concave surface, or in other words, between side wall sections 21b corresponding to the side surfaces of the second paper roll 17 is almost the same length as the paper width of the second paper roll 17, as shown in FIG. 9.

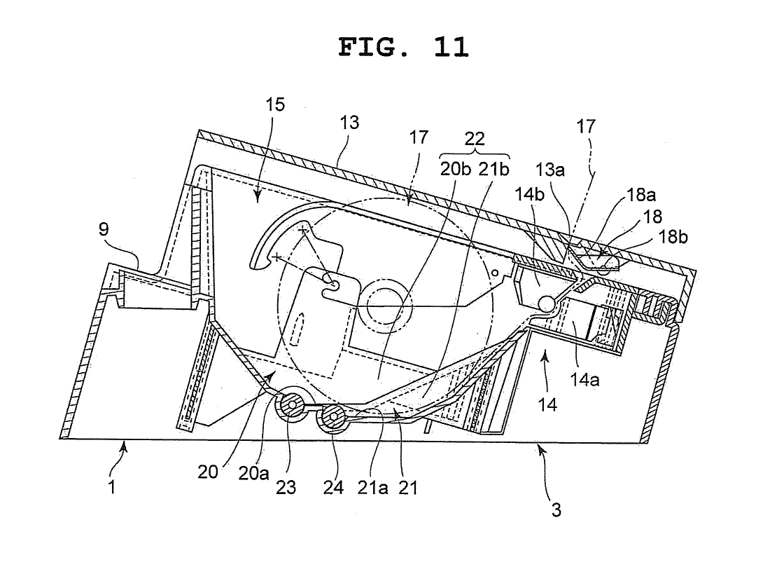

As a result, the second housing section 21 is structured such that, when the second paper roll 17 is inserted therein from above, the second paper roll 17 rolls over the bottom section 21a formed into a concave surface curved into a substantially circular-arc shape in the second housing section 21, and is naturally arranged in the lowest portion of the bottom section 21a, as shown in FIG. 11.

In addition, in the second housing section 21, the lowest portion of the bottom section 21a is provided to be shifted towards the paper feed-out direction (the right side in FIG. 9), or in other words, the direction in which the printer section 14 is positioned in the device body 1 from the lowest portion of the bottom section 20a of the first housing section 20, as shown in FIG. 9 to FIG. 11. As a result, when the second paper roll 17 is housed within the second housing section 21, the rotation center thereof is positioned to be shifted further towards the paper feed-out direction than the rotation center of the first paper roll 16 housed within the first housing section 20.

In this instance, the second housing section 21 is provided in the bottom section 20a of the first housing section 20 such that the length S2 is shorter than the length S1 between the side wall sections 20b of the first housing section 20, or in other words, almost the same length as the paper width of the second paper roll 17, as shown in FIG. 7 to FIG. 11. As a result, the second housing section 21 is structured such that, when the second paper roll 17 is housed therewithin, the center of the second paper roll 17 in the paper width direction coincides with the center of the first paper roll 16 in the paper width direction.

As described above, the paper roll guiding section 22 of the paper roll housing section 15 is structured to guide the first paper roll 16 or the second paper roll 17 inserted into the paper roll housing section 15 to the first housing section 20 or the second housing section 21 corresponding to the paper width, by providing the bottom section 21a of the second housing section 21 that is a step lower than the bottom section 20a of the first housing section 20, as shown in FIG. 7 to FIG. 11.

That is, as shown in FIG. 7 to FIG. 11, the paper roll guiding section 22 is constituted by the side wall sections 20b which is provided within the first housing section 20 and guides the first paper roll 16 while restricting the positions of the side surfaces thereof, and the side wall sections 21b which is provided within the second housing section 21 and guides the second paper roll 17 while restricting the positions of the lower side surfaces thereof.

As a result, the paper roll guiding section 22 is structured such that the first paper roll 16 or the second paper roll 17 inserted into the paper roll housing section 15 is guided by the side wall sections 20b of the first housing section 20 or the side wall sections 21b of the second housing section 21 to the first housing section 20 or the second housing section 21 corresponding to the paper width, as shown in FIG. 7 to FIG. 11.

In addition, a first rotating roller 23 and a second rotating roller 24 are provided within the first housing section 20 and the second housing section 21, respectively, as shown in FIG. 7 to FIG. 9. More specifically, the first rotating roller 23, which is used to rotate the first paper roll 16 in the paper feed-out direction, is rotatably arranged in an area near the lowest portion of the bottom section 20a of the first housing section 20, or in other words, an area slightly posterior to the rotation center of the first paper roll 16 housed within the first housing section 20 (the left side in FIG. 9).

As a result, the first paper roll 16 arranged inside the first housing section 20 is consecutively fed out towards the printer section 14 while rotating on and with the first rotating roller 23, when being consecutively pulled into the printer section 14 and printed with print information, as shown in FIG. 10.

Also, the second rotating roller 24, which is used to rotate the second paper roll 17 in the paper feed-out direction, is rotatably arranged in an area near the lowest portion of the bottom section 21a of the second housing section 21, or in other words, an area slightly posterior to the rotation center of the second paper roll 17 housed within the second housing section 21 (the left side in FIG. 9), as shown in FIG. 7 to FIG. 9.

As a result, the second paper roll 17 arranged inside the second housing section 21 is consecutively fed out towards the printer section 14 while rotating on and with the second rotating roller 24, when being consecutively pulled into the printer section 14 and printed with print information, as shown in FIG. 11.

Next, operations of this electronic register will be described.

In this electronic register, when the operator operates the touch input section 6 of the input display unit 2 and inputs information such as the price and the name of a product that a customer is purchasing, the inputted information is displayed on the touch input section 6 and the display panel 11 of the rotational display unit 4, whereby the operator can check the inputted information by viewing the information displayed on the touch input section 6 of the input display unit 2, and the customer can check the inputted information by viewing the information displayed on the display panel 11 of the rotational display unit 4.

The information displayed as described above is printed on either of the first paper roll 16 or the second paper roll 17 by the printing section 14 and issued as a receipt. When issuing the receipt, the operator operates the printer section 14 by performing a touch operation on the touch input section 6. For example, when the first paper roll 16 is in the first housing section 20 of the paper roll housing section 15 in the printer unit 3 of the device body 1, the first paper roll 16 is consecutively fed between the print section 14a and the platen section 14b of the printer section 14, and the printer section 14 sequentially prints print information on the first paper roll 16 that is being fed thereto.

The first paper roll 16 on which the print information has been printed as described above by the printer section 14 is sequentially fed out above the printer 14. This fed-out first paper roll 16 pushes the drip-proof shutter 18 upward by the ejection force, whereby the shutter plate 18a of the drip-proof shutter 18 rotates in the clockwise direction around the supporting shaft 18b. Here, the shutter plate 18a is being rotatably supported by the supporting shaft 18b in a fine weight balance, and as a result it rotates by the ejection force of the first paper roll 16.

Consequently, the shutter plate 18a of the drip-proof shutter 18 rotates in the clockwise direction around the supporting shaft 18b, and the first paper roll 16 passes through the drip-proof shutter 18 and is ejected above the printer cover 13 from the recording paper ejection port 13a of the printer cover 13. This ejected first paper roll 16 is issued as a receipt.

When the second paper roll 17 is in the second housing section 21 of the paper roll housing section 15, the second paper roll 17 is consecutively pulled into the printer section 14, and the printer section 14 sequentially prints print information on the second paper roll 17 that is being pulled thereinto, as in the case of the first paper roll 16. The printed second paper roll 17 passes through the drip-proof shutter 18, and is ejected from the recording paper ejection port 13a of the printer cover 13 to be issued as a receipt.

Next, operations when either of the first paper roll 16 and the second paper roll 17 is housed within the paper roll housing section 15 will be described.

First, in a case where the first paper roll 16 is housed, the first paper roll 16 is inserted from above into the first housing section 20 of the paper roll housing section 15. Then, the first paper roll 16 rolls over the bottom section 20a formed into a concave surface curved into a substantially circular-arc shape in the first housing section 20, with the positions of its side surfaces being restricted by the side wall sections 20b of the first housing section 20, and then is naturally arranged in the lowest position of the bottom section 20a formed into a concave surface, as shown in FIG. 10.

As a result, the first paper roll 16 is rotatably arranged on the first rotating roller 23 provided in the bottom section 20a of the first housing section 20, as shown in FIG. 10. Accordingly, the first paper roll 16 is consecutively and smoothly fed out while rotating on and with the first rotating roller 23 when the printer section 14 prints print information on the first paper roll 16.

That is, the front edge of the first paper roll 16 is fed between the print section 14a and the platen section 14b of the printer section 14 with the first paper roll 16 being housed within the first housing section 20, and print information is sequentially printed. In this printing operation, the first paper roll 16 rotates on and with the first rotating roller 23 by being consecutively pulled out in response to the printing performed by the printer section 14. Thus, the first paper roll 16 is smoothly and favorably fed into the printer section 14.

Also, in a case where the second paper roll 17 is housed, the second paper roll 17 is inserted from above to be positioned inside the second housing section 21 provided a step lower than in the bottom section 20a of the first housing section 20 of the paper roll housing section 15. Then, the second paper roll 17 rolls over the bottom section 21a formed into a concave surface shaped into a substantially circular-arc shape in the second housing section 21, with the positions of its side surfaces being restricted by the side wall sections 21b on the sides of the second housing section 21, and then is naturally arranged in the lowest position of the bottom section 21a formed into a concave surface, as shown in FIG. 11.

In this instance, even if the second paper roll 17 is slightly misaligned with the inside of the second housing section 21 when being inserted therein, the second paper roll 17 is naturally inserted into the second housing section 21 by rolling over the bottom section 20a of the first housing section 20 and the bottom section 21a of the second housing 21, while straddling both the bottom section 21a and the bottom section 20a.

That is, when the second paper roll 17 rolls over the bottom section 20a of the first housing section 20 and the bottom section 21a of the second housing section 21 while straddling both the bottom section 21a and the bottom section 20a, the second paper roll 17 is naturally inserted into the second housing section 21b while rolling because the lowest portion of the bottom section 20a of the first housing section 20 and the lowest portion of the bottom section 21a of the second housing 21 have been formed to be shifted from each other toward the front and back. As a result, the second paper roll 17 is naturally arranged in the lowest portion of the bottom section 21a of the second housing section 21, with the positions of the side surfaces of the second paper roll 17 being restricted by the side wall sections 21b on the sides of the second housing section 21.

As a result, the second paper roll 17 is rotatably arranged on the second rotating roller 24 provided in the bottom section 21a of the second housing section 21, as shown in FIG. 11. Accordingly, the second paper roll 17 is consecutively and smoothly fed out while rotating on and with the second rotating roller 24 when the printer section 14 prints print information on the second paper roll 17, as in the case of the first paper roll 16.

That is, the front edge of the second paper roll 17 is fed between the print section 14a and the platen section 14b of the printer section 14 with the second paper roll 17 being housed within the second housing section 21, and print information is sequentially printed. In this printing operation, the second paper roll 17 rotates on and with the second rotating roller 24 by being consecutively pulled out in response to the printing performed by the printer section 14. Thus, the second paper roll 17 is smoothly and favorably fed into the printer section 14.

As described above, the paper roll housing structure of this electronic register includes the first housing section 20 that houses the first paper roll 16 having the first paper width corresponding to the paper width, the second housing section 21 that houses the second paper roll 17 having the second paper width that is smaller than the first paper width corresponding to the paper width, and the paper roll guiding section 22 that guides the first paper roll 16 or the second paper roll 17 inserted into the paper roll housing section 15 to the first housing section 20 or the second housing section 21 corresponding to the paper width, by providing the bottom section 21a of the second housing section 21a step lower than the bottom section 20a of the first housing section 20. Accordingly, the number of the components of an electronic device such as this can be reduced and thereby the cost can be reduced using a simpler structure.

That is, in the paper roll housing structure, in a case where the first paper roll 16 is housed, the first paper roll 16 is favorably guided into and housed within the first housing section 20 by the paper roll guiding section 22 corresponding to the paper width. Also, in a case where the second paper roll 17 is housed, the second paper roll 17 is favorably guided into and housed within the second housing section 21 by the paper roll guiding section 22 corresponding to the paper width.

Therefore, through a simple operation of merely inserting either of the first paper roll 16 and the second paper roll 17 into the paper roll housing section 15, the first paper roll 16 or the second paper roll 17 is easily and favorably housed within the corresponding housing section 20 or 21 without special operations being performed. In addition, since the structure is simple, additional components as separate components are not required and the number of the components is small, whereby the assembly operation can be simplified and the cost can be reduced.

In this instance, by providing the bottom section 21a of the second housing section 21 that is a step lower than the bottom section 20a of the first housing section 20, the side wall, sections 20b which are provided on the sides of the first housing section 20 and restrict the positions of the side surfaces of the first paper roll 16, and the side wall sections 21b which are provided on the sides of the second housing section 21 and restrict the positions of the lower side surfaces of the second paper roll 17 can be formed in the paper roll guiding section 22, and the first paper roll 16 or the second paper roll 17 can be unfailingly guided into the first housing section 20 or the second housing section 21 by the paper roll guiding section 22, corresponding to the paper width.

That is, this paper roll guiding section 22 can be easily manufactured by the second housing section 21 that houses the second paper roll 17 having a narrower paper width simply being provided a step lower than the bottom section 20a of the first housing section 20 that houses the first paper roll having a wider paper width, by which the first paper roll 16 or the second paper roll 17 inserted into the paper roll housing section 15 can be unfailingly guided into the first housing section 20 or the second housing section 21 corresponding to the paper width.

Accordingly, with the paper roll guiding section 22, the first paper roll 16 can be unfailingly and favorably guided by the positions of its side surfaces being restricted by the side wall sections 20b on the sides of the first housing section 20, when being inserted into the first housing section 20. As a result, the first paper roll 16 can be unfailingly and favorably arranged in the first housing section 20. This enables the first paper roll 16 to be easily handled and the setting thereof to be easily performed.

Also, with the paper roll guiding section 22, the second paper roll 17 can be unfailingly and favorably guided by the positions of its side surfaces being restricted by the side wall sections 21b on the sides of the second housing section 21, when being inserted into the second housing section 21. As a result, the second paper roll 17 unfailingly and favorably arranged in the second housing section 21. This enables the second paper roll 17 to be easily handled and the setting thereof to be easily performed.

In this instance, the bottom section 20a of the first housing section 20 and the bottom section 21a of the second housing section 21 are each formed into a concave surface curved into a substantially circular-arc shape. Accordingly, the first paper roll 16 can be unfailingly and favorably arranged in a predetermined position in the first housing section 20 with stability, by simply being inserted into the first housing section 20. In addition, the second paper roll 17 can be unfailingly and favorably arranged in a predetermined position in the second housing section 21 with stability, by simply being inserted into the second housing section 21.

That is, when the first paper roll 16 is inserted into the first housing section 20, it rolls over the bottom section 20a of the first housing section 20 along the concave surface having a substantially circular-arc-shape and is naturally arranged in the lowest portion of the bottom section 20a formed into a concave surface. Therefore, the first paper roll 16 can be unfailingly and favorably arranged in a predetermined position in the first housing section 20 with stability, by simply being placed in the first housing section 20 in a normal way. This also enables the first paper roll 16 to be easily handled and the setting thereof to be easily performed.

Similarly, when the second paper roll 17 is inserted into the second housing section 21 provided in the bottom section 20a of the first housing section 20, it rolls over the bottom section 21a of the second housing section 21 along the concave surface having a substantially circular-arc-shape and is naturally arranged in the lowest portion of the bottom section 21a formed into a concave surface. Therefore, the second paper roll 17 can be unfailingly and favorably arranged in a predetermined position in the second housing section 21 with stability, by simply being placed in the second housing section 21 in a normal way. This also enables the second paper roll 17 to be easily handled and the setting thereof to be easily performed.

In this instance, the lowest portion of the bottom section 20a of the first housing section 20 and the lowest portion of the bottom section 21a of the second housing section 21 are provided at positions shifted from each other along the paper feed-out direction. Therefore, the rotation center of the first paper roll 16 and the rotation center of the second paper roll 17 can be shifted in the paper feed-out direction of the first paper roll 16 and the second paper roll 17. As a result, through a simple operation of merely placing the first paper roll 16 or the second paper roll 17 inside the first housing section 20 or the second housing section 21 in a normal way, the first paper roll 16 or the second paper roll 17 can be precisely and favorably restricted to a suitable position in the first housing section 20 or the second housing section 21, without special operations being performed.

In particular, the second housing section 21 is provided such that the bottom section 21a thereof is formed below the bottom section 20a of the first housing section 20, and the lowest portion of this bottom section 21a is formed at a position shifted in the paper feed-out direction from the position of the lowest portion of the bottom section 20a of the first housing section 20. As a result, when the second paper roll 17 is arranged inside the second housing section 21 in the bottom section 20a of the first housing section 20 so as to be housed therein, the position of the second paper roll 17 is restricted corresponding to the paper width by the side wall sections 21b on the sides of the second housing section 21, whereby the second paper roll 17 is favorably housed within the second housing section 21.

Moreover, in this paper roll housing structure, the first rotating roller 23 for rotating the first paper roll 16 in the paper feed-out direction is rotatably provided in the bottom section 20a of the first housing section 20. Therefore, when being consecutively pulled out and printed with print information by the printer section 14, the first paper roll 16 can be rotated on and with the first rotating roller 23 so as to be sequentially fed out, and thereby smoothly and favorably fed out from inside the first housing section 20.

In addition, the second rotating roller 24 for rotating the second paper roll 17 in the paper feed-out direction is rotatably provided in the bottom section 21a of the second housing section 21. Therefore, when being consecutively pulled out and printed with print information by the printer section 14, the second paper roll 17 can be rotated on and with the second rotating roller 24 so as to be sequentially fed out, and thereby smoothly and favorably fed out from inside the second housing section 21, as in the case of the first paper roll 16.

Note that, although the above-described embodiment describes an instance in which the second housing section 21 is provided in the bottom section 20a of the first housing section 20 with an intermediate point between the side wall sections 20b on the sides of the first housing section 20 as the center, the present invention is not limited thereto. For example, a structure may be adopted in which one side wall section 20b in the first housing section 20 coincides with one side wall section 21b in the second housing section 21 and, in this state, the second housing section 21 is provided to be shifted to one side of the bottom section 20a in the first housing section 20.

In addition, although the above-described embodiment describes an instance in which the bottom section 20a of the first housing section 20 and the bottom section 21a of the second housing section 21a are each formed into a concave surface curved into a substantially circular-arc shape, the bottom section 20a and the bottom section 21a are not necessarily required to be formed into a concave surface curved into a substantially circular-arc shape. For example, they may be formed into flat surfaces or tilted surfaces having different heights.

Moreover, although the above-described embodiment describes a two-level structure in which the bottom section 21a of the second housing section 21 is provided in the bottom section 20a of the first housing section 20 that is a step lower than the bottom section 20a, and two types of paper rolls 16 and 17 having different paper widths are selectively housed, the present invention is not limited thereto. For example, a three-level structure may be adopted in which the bottom section of a second housing section is provided in the bottom section of a first housing section that is a step lower than the bottom section of the first housing section, the bottom section of a third housing section is provided in the bottom section of the second housing that is a step lower than the bottom section of the second housing, and three types of paper rolls having different paper widths can be selectively housed.

Furthermore, although the present invention has been applied to an electronic register in the above-described embodiment, it is not necessarily required to be applied to an electronic register and can be widely applied to electronic devices having a printer, such as mobile information terminals and photocopiers.

While the present invention has been described with reference to the preferred embodiments, it is intended that the invention be not limited by any of the details of the description therein but includes all the embodiments which fall within the scope of the appended claims.

What is claimed is:

1. An electronic device having a printer that selectively houses any one of a plurality of paper rolls for different paper widths within a device body comprising:
a first housing section which houses a first paper roll having a first paper width corresponding to the first paper width;
a second housing section which houses a second paper roll having a second paper width that is narrower than the first paper width corresponding to the second paper width; and
a paper roll guiding section which guides the first paper roll or the second paper roll inserted into the electronic device to either one of the first housing section and the second housing section corresponding to the first paper width or the second paper width, by providing a bottom section of the second housing section in a bottom section of the first housing section that is a step lower than the bottom section of the first housing section.

2. The electronic device according to claim 1, wherein the paper roll guiding section includes side wall sections which are provided on both sides of the first housing section and restrict positions of both side surfaces of the first paper roll, and side wall sections which are provided on both sides of the second housing section and restrict positions of lower portions of both side surfaces of the second paper roll.

3. The electronic device according to claim 1, wherein the bottom section of the first housing section and the bottom section of the second housing section are each formed into a concave surface curved into a substantially circular-arc shape.

4. The electronic device according to claim 1, wherein a lowest portion of the bottom section of the first housing section and a lowest portion of the bottom section of the second housing section are provided at positions shifted from each other along a paper feed-out direction.

5. The electronic device according to claim 1, wherein the bottom section of the first housing section has a first rotating roller rotatably provided therein for rotating the first paper roll in a paper feed-out direction, and the bottom section of the second housing section has a second rotating roller rotatably provided therein for rotating the second paper roll in the paper feed-out direction.
